(19) United States
(12) Patent Application Publication
(10) Pub. No.: US 2021/0078492 A1
(43) Pub. Date: Mar. 18, 2021

(54) OPERATION STATUS DETECTION DEVICE

(71) Applicant: KABUSHIKI KAISHA TOKAI-RIKA-DENKI-SEISAKUSHO, Aichi (JP)

(72) Inventors: Kenji NARUMI, Aichi (JP); Hidenobu HANAKI, Aichi (JP)

(73) Assignee: Kabushiki Kaisha Tokai-Rika-Denki-Seisakusho, Aichi (JP)

(21) Appl. No.: 16/646,842

(22) PCT Filed: Aug. 21, 2018
(86) PCT No.: PCT/JP2018/030851

§ 371 Date: Mar. 12, 2020

(30) Foreign Application Priority Data
Sep. 20, 2017 (JP) 2017-179944

(51) Int. Cl. B60Q 3/283; B60W 60/00; B60W 50/14; B60W 40/08

(52) U.S. Cl. CPC B60Q 3/283; B60W 60/0053; B60W 10/20; B60W 40/08; B60W 50/14

(57) ABSTRACT

An operation status detection device is provided that detects if a vehicle operator is able to properly manually operate an automotive steering wheel when a driving assist device is on, and if not, maintains the “on” state of the driving assist device. The detection device includes a request part that requests that the vehicle operator grip the steering wheel at a designated position to perform an operation task that may be performed manually. The device further includes both a detection part having sensors that detect whether the vehicle operator is properly gripping the steering wheel, and a determination part that determines if the vehicle operator is able to operate the steering wheel based on whether completion of the operation task is detected by the detection part within a predetermined time after the request part requests the operation task.

### TECHNICAL FIELD

The present disclosure relates to an operation status detection device for detecting an operation status of an occupant when the occupant performs a driving operation of a vehicle.

### BACKGROUND ART

For example, in a vehicle-use information display device described in International Publication No. 2015/145605, a light emitting part is mounted on a steering wheel. A light emitting control part changes a light emitting state of the light emitting part for urging a driver to shift from automatic driving to manual driving. The light emitting control part makes the light emitting part emit light in order of an upper portion of the steering wheel, a position of the steering wheel at which the driver grips the steering wheel, or in order of the upper portion of the steering wheel, a lower portion of the steering wheel, and the position of the steering wheel at which the driver grips the steering wheel. The light emitting control part also changes a time period until the light emitting part emits light to the position at which the driver grips the steering wheel corresponding to a state of an automatic driving system.

### SUMMARY OF INVENTION

### Technical Problem

When the driver switches a driving mode from automatic driving where the automatic driving system performs a driving control to a manual driving mode where the driver performs a driving operation, it is necessary for the driver to grip the steering wheel while being attentive to performing a driving operation instead of gripping the steering wheel in an inattentive state.

This disclosure has been made in view of the above-mentioned fact, and it is an object of this disclosure to provide an operation status detection device capable of detecting whether or not an occupant is in a state where the occupant can properly perform a driving operation.

### Solution to Problem

According to a first aspect of this disclosure, there is provided an operation status detection device which includes: a request part configured to request that an occupant performs an operation task of gripping a designated position of a steering wheel, which is gripped and operated by the occupant when the occupant performs a driving operation, and which is operated by a driving assist device of a vehicle when the driving operation is performed by the driving assist device; a detection part configured to detect the operation task of the occupant relative to the steering wheel, and a determination part configured to determine whether or not the occupant is able to operate the steering wheel based on whether or not completion of the operation task is detected by the detection part within a predetermined time after the request part requests the operation task.

According to a second aspect of this disclosure, in the first aspect of this disclosure, the request part includes a light emitting part that is mounted on the steering wheel, and that performs one of calling the occupant's attention to performance of the operation task, or notifying the occupant of the designated position by being turned on.

According to a third aspect of this disclosure, in the first aspect or the second aspect of this disclosure, the designated position is disposed at one place on each of left and right sides, with respect to a vehicle straight advancing steering position, of the steering wheel.

According to a fourth aspect of this disclosure, in the third aspect of this disclosure, the operation status detection device includes a plurality of the detection parts on each of the left and right sides with respect to the vehicle straight advancing steering position of the steering wheel, and the designated position is a position that corresponds to the detection part at which a gripping time of the occupant, which is preliminarily detected by the detection part in a case in which the vehicle travels in a manual operation mode, is shortest at the respective left and right sides with respect to the vehicle straight advancing steering position of the steering wheel.

According to a fifth aspect of this disclosure, in any one of the first to fourth aspects of this disclosure, the determination part is configured to determine that the occupant is able to operate the steering wheel in a case in which completion of the operation task is detected within a predetermined time after the operation task is requested.

According to a sixth aspect of this disclosure, in any one of the first to fourth aspects of this disclosure, the determination part is configured to determine that the occupant is able to operate the steering wheel in a case in which a completion state of the operation task continues.

According to a seventh aspect of this disclosure, in any one of the first to fourth aspects of disclosure, the request part requests the operation task again in a case in which completion of the operation task is not detected within a predetermined time after the operation task is requested.

According to an eighth aspect of this disclosure, in the seventh aspect of disclosure, the designated position is changed when the operation task is requested again.

According to a ninth aspect of this disclosure, in the seventh aspect or the eighth aspect of this disclosure, the determination part is configured to determine that the occupant is not able to operate the steering wheel in a case in which the completion of the operation task is not detected within the predetermined time despite the operation task having been requested a predetermined number of times.

In the first aspect of this disclosure, with respect to the steering wheel, which is gripped and operated by the occupant when the occupant performs the driving operation, and which is operated by the driving assist device of the vehicle when the driving operation is performed by the driving assist device, the request part requests that the occupant performs the operation task of gripping the designated position of the steering wheel. The detection part detects whether or not the occupant completes the operation task based on the request.

The determination part determines whether or not the occupant is in a state where the occupant can operate the steering wheel based on whether or not the operation task is completed and whether or not an elapsed time until the completion of the operation task is within the predetermined time. With such operations, it is possible to detect whether or not the occupant is in a state where the occupant can properly perform the driving operation.

In the second aspect of this disclosure, the light emitting part is mounted on the steering wheel, and the request part performs either one of calling the occupant's attention to perform the operation task or notifying the occupant of the designated position in the operation task by turning on the light emitting part. With such an operation, it is possible to perform either one of calling the occupant's attention to perform the operation task or notifying the occupant of the designated position. Accordingly, it is possible to properly detect whether or not the designated position of the steering wheel is gripped.

In the third aspect of this disclosure, the designated position of the operation task is disposed at one place on each of the left and right sides, with respect to a vehicle straight advancing steering position, of the steering wheel as viewed from an occupant side. With such a configuration, the operation task can be performed simply, and it is possible to detect whether or not the occupant can properly perform a driving operation by the simple operation task.

In the fourth aspect of this disclosure, the designated position of the operation task corresponds to the detection part where a gripping time of the occupant which is preliminarily detected by the detection part when the vehicle travels in a manual operation mode is shortest at respective left and right sides with respect to the vehicle straight advancing steering position of the steering wheel. With such a configuration, it is possible to prevent the occurrence of an erroneous determination in determining whether or not the occupant is in a state where the occupant can properly perform a driving operation.

In the fifth aspect of this disclosure, the determination part determines that the occupant can perform an operation of the steering wheel when completion of the operation task is detected within a predetermined time after the operation task is requested. Accordingly, when the occupant completes the operation task without delay, it is possible to detect that the occupant is in a state where the occupant can properly perform a driving operation.

In the sixth aspect of this disclosure, the determination part determines that the occupant can perform an operation of the steering wheel when a completion state of the operation task is continued. When the occupant operates the steering wheel, the occupant assumes a state where the occupant grips the steering wheel. Accordingly, it is detected that the occupant can properly perform a driving operation.

In the seventh aspect of this disclosure, when the completion of the operation task is not detected within a predetermined time after the operation task is requested, the operation task is requested again. Accordingly, it is possible to detect whether or not the occupant is in a state where the occupant can properly perform a driving operation also when the completion of the operation task is delayed although the state is a state where the occupant can properly perform a driving operation.

In the eighth aspect of this disclosure, when the operation task is requested again, the designated position of the operation task which differs from the designated position of the operation task of the preceding time is set. Accordingly, even when the operation task is requested again, it is possible to detect with high accuracy whether or not the state is a state where the occupant can properly perform a driving operation.

In the ninth aspect of this disclosure, when the completion of the operation task is not detected even when the operation task is requested predetermined number of times, it is determined that the occupant cannot operate the steering wheel. Accordingly, it is possible to clearly detect that the state is not a state where the occupant can properly perform a driving operation.

### BRIEF DESCRIPTION OF DRAWINGS

FIG. 1 is a schematic constitutional view of a steering device according to this embodiment.

FIG. 2 is a block diagram showing the schematic configuration of an operation detection device.

FIG. 3 is a flowchart showing operation detection processing.

FIG. 4A is a schematic view showing a main part of a steering wheel showing a state where a determination task is requested.

FIG. 4B is a schematic view showing the main part of the steering wheel showing a completion state of the determination task.

### DESCRIPTION OF EMBODIMENTS

Hereinafter, an embodiment of this disclosure is described in detail with reference to drawings.

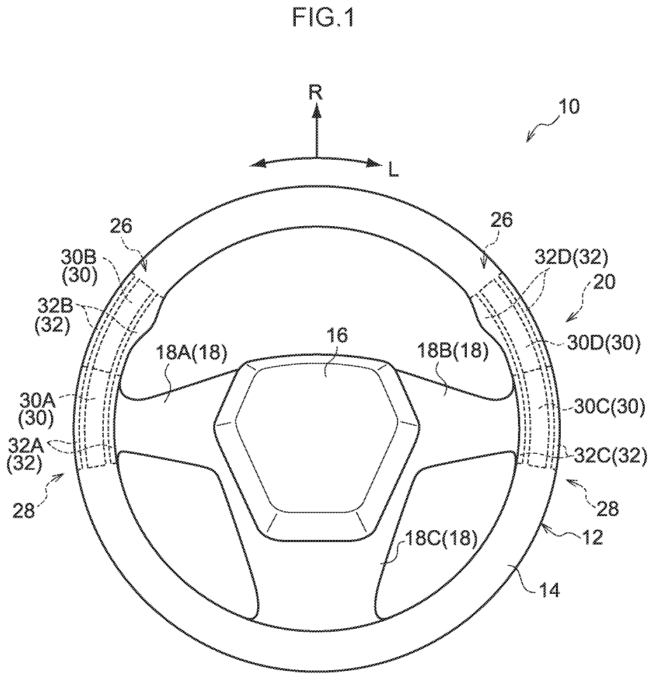

FIG. 1 shows a steering device 10 which forms a driving operation device according to this embodiment. The steering device 10 includes a steering wheel 12 which is an object to be operated. FIG. 1 is a plan view of the steering wheel 12 as viewed from an occupant side.

The steering device 10 includes a steering shaft (not shown in the drawing), and the steering shaft is rotatably supported by a vehicle body in front of a driver's seat. A vehicle is steered corresponding to rotation of the steering shaft when the steering shaft is rotated.

The steering wheel 12 includes a rim portion 14 having a circular annular shape which forms a grip portion, a boss portion 16, and spoke portions 18. The boss portion 16 is disposed at an axis portion of the rim portion 14, and the rim portion 14 and the boss portion 16 are connected to each other by the spoke portions 18. The steering wheel 12 has a core not shown in the drawing which forms a frame (skeleton). The rim portion 14, the boss portion 16 and the spoke portions 18 are formed by covering the core with a cover member (not shown in the drawing) which forms a covering member and an ornamental member.

The steering wheel 12 is mounted on the steering shaft by fixing the boss portion 16 to an upper end portion of the steering shaft, and the rim portion 14 is integrally rotatable with the steering shaft about an axis of the steering shaft. In such a configuration, the steering wheel 12 is disposed in front of a seat (driver's seat) on which an occupant who performs a driving operation of the vehicle is seated in a longitudinal direction of the vehicle, and when the occupant grips the rim portion 14 and performs a rotation operation of the rim portion 14 about the axis of the steering shaft, the steering shaft is rotated so that the vehicle is steered.

In the description made hereinafter, the rotation operation which the occupant performs by gripping the rim portion 14 of the steering wheel 12 is referred to as a steering operation. FIG. 1 shows a straight advancing steering position which is a state where the vehicle is made to advance straightly by the steering wheel 12. In FIG. 1, a circumferential direction of the steering wheel 12 (steering circumferential direction) is indicated by an arrow L, and an example of a radially outward direction of the steering wheel 12 (steering radially outward direction) is indicated by an arrow R.

With respect to the spoke portions 18, at the straight advancing steering position of the steering wheel 12, the spoke portion 18 disposed on a left side as viewed from the occupant is referred to as the spoke portion 18A, the spoke portion 18 disposed on a right side as viewed from the occupant is referred to as the spoke portion 18B, and the spoke portion 18 disposed on an occupant side is referred to as the spoke portion 18C.

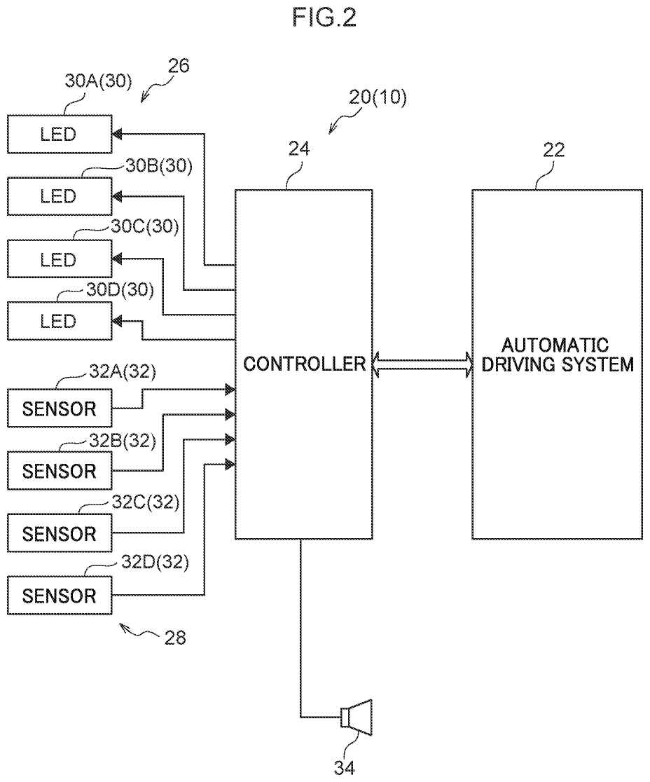

The steering device 10 includes an operation detection device 20 which forms an operation status detection device. An automatic driving system 22 which forms a driving assist device is mounted on the vehicle. FIG. 2 is a block diagram showing the schematic configuration of the operation detection device 20.

In the vehicle which includes the automatic driving system 22, traveling in a manual driving mode where a driving operation is performed by steering of the steering wheel 12 by an occupant, and a traveling in an automatic driving mode where steering of the steering wheel 12 and a traveling control are performed by the automatic driving system 22 are possible.

The automatic driving system 22 includes a drive source (an actuator not shown in the drawing) for steering which rotates the steering shaft. The automatic driving system 22 performs steering of the vehicle by rotating the steering shaft by controlling the drive source for steering in the automatic driving mode. With such an operation, in the automatic driving mode, the vehicle can travel even when the occupant does not touch the steering wheel 12. The drive source for steering may be disposed on a steering shaft side and on a steering wheel side respectively, and the steering shaft and the steering wheel may be operated in a synchronized manner.

The automatic driving system 22 acquires various information relating to traveling of the vehicle such as a traveling state of the vehicle, a traveling environment around the vehicle (map information, image information of surrounding of the vehicle and the like) and the like, and performs a steering control of the vehicle, a speed control and the like based on the acquired information thus allowing a vehicle to travel toward a preliminarily set destination. The automatic driving system 22 is operated in response to an instruction from an occupant, and makes the vehicle travel in an automatic driving mode. Further, the automatic driving system 22 switches a driving mode from an automatic driving mode to a manual driving mode at a preliminarily set timing such as a case where an occupant requests such mode switching, a case where a vehicle arrives at a position close to a destination, a case where the vehicle exits from a limited-access road such as an expressway to a general road. With such a switching operation, the vehicle can travel by a driving operation such as steering performed by an occupant (manual driving mode). A known configuration is applicable to the automatic driving system 22 and hence, the detailed description of the automatic driving system 22 is omitted in this embodiment.

The operation detection device 20 includes a controller (ECU) 24. The controller 24 includes a microcomputer (not shown in the drawing) to which a CPU, a RAM, a ROM, a non-volatile memory and the like are connected. The operation detection device 20 includes a light emitting part 26 which forms a request part and a detection part 28. The operation detection device 20 further includes a speaker 34. The controller 24 can notify an occupant of various information by a voice using the speaker 34.

The light emitting part 26 includes a plurality of lamp portions 30 (lamp portions 30A to 30D in this embodiment) which respectively include an LED as a light source, and the lamp portions 30 emit light of orange color. The lamp portions 30 are electrically connected to the controller 24. The controller 24 controls emission of light from the lamp portions 30 by controlling turning on and off of the light sources of the lamp portions 30. Emitted light colors of the lamp portions 30 is not limited to orange, and may be any color such as yellow, red, green, or blue. Further, it is preferable that a quantity of light emitted from the lamp portions 30 is a quantity of light which prevents an occupant from feeling glare. It is also preferable that a quantity of light at night where the inside of a cabin is dark is set lower than a quantity of light at daytime where the inside of the cabin is bright.

The detection part 28 includes a plurality of sensors 32 (sensors 32A to 32D in this embodiment). An electrostatic capacity sensor, a pressure sensor or the like which detects that an occupant is touching the steering wheel 12 is used as the sensor 32. The sensors 32 are electrically connected to the controller 24, and the controller 24 detects the sensor 32 which the occupant touches among the plurality of sensors 32 by reading an output signal from the sensor 32.

As shown in FIG. 1, on the steering wheel 12, the lamp portion 30A is disposed on the rim portion 14 in the vicinity of the spoke portion 18A, the lamp portion 30B is disposed on a right side (a side opposite to the occupant) of the lamp portion 30A in the steering circumferential direction, and the lamp portions 30A, 30B correspond to a left hand of the occupant. In the steering wheel 12, the lamp portion 30C is disposed on the rim portion 14 in the vicinity of the spoke portion 18B, and the lamp portion 30D is disposed on a left side (a side opposite to the occupant) of the lamp portion 30C in the steering circumferential direction. The lamp portions 30C, 30D correspond to a left hand of the occupant. The respective lamp portions 30 (30A to 30D) are embedded in the cover member of the rim portion 14 in a state where the lamp portions 30 are directed toward an occupant side on the rim portion 14, and the lamp portions 30 emit light such that the occupant can visually recognize the light.

The sensors 32 (32A to 32D) are arranged on the rim portion 14 adjacently to the lamp portions 30 (30A to 30D) in the circumferential direction of the rim portion 14, and are mounted on a surface of the cover member of the rim portion 14 or in the vicinity of the surface. In the steering wheel 12, when an occupant grips portions of the lamp portions 30A to 30D on the rim portion 14, the sensors 32A to 32D detect that the occupant is gripping the sensors 32. The sensors 32 (32A to 32D) may be arranged on both sides of the lamp portions 30 (30A to 30D) in the circumferential direction of the rim portion 14. Alternatively, the sensors 32 (32A to 32D) may be mounted in a winding manner around the rim portion 14 such that both ends of the sensors 32 are disposed adjacently to both sides of the lamp portions 30 in the circumferential direction of the rim portion 14. FIG. 1 shows a mode where the sensors 32 (32A to 32D) are mounted on the rim portion 14 in a winding manner, and the sensors 32 are visually recognized from an occupant side at the inside of the rim portion 14 in the radial direction and at the outside of the rim portion 14 in the radial direction. The sensors 32 (32A to 32D) are arranged at least one of the inside of the rim portion 14 in the radial direction or outside of the rim portion 14 in the radial direction.

With such a configuration, when an occupant grips the steering wheel 12 in the vicinity of the spoke portions 18A, 18B of the rim portion 14 (the positions of the lamp portions 30A, 30C or the positions including approximately a quarter after nine when the steering wheel 12 is used as a clock face), gripping of the steering wheel 12 is detected by the sensors 32A and 32C. On the other hand, when the occupant grips the steering wheel 12 at the positions of the lamp portions 30B, 30D of the rim portion 14 (the positions including approximately ten after ten when the steering wheel 12 is used as a clock face), gripping of the steering wheel 12 is detected by the sensors 32B and 32D.

A determination task is preliminarily stored as an operation task in the controller 24, and the determination task requests an operation of the steering wheel 12 by an occupant. In this embodiment, the determination task requests the occupant to grip designated portions set on the rim portion 14 of the steering wheel 12. In requesting the determination task to the occupant, the controller 24 notifies the occupant of the designated positions by turning on the lamp portions 30 which indicate the designated positions. The controller 24 detects whether or not the occupant is gripping the designated positions by the sensors 32, and determines the execution of the determination task by the occupant and the completion of such execution. Further, the controller 24 determines, as a determination part, the reaction of the occupant with respect to the determination task based on a time period until completion of the determination task (a time period from a point of time that the lamp portions 30 are turned on to a point of time that gripping of the steering wheel 12 by the occupant is detected by the sensor 32) or the like. The controller 24 turns off the lamp portions 30 when the occupant completes the determination task or completes the determination.

The controller 24 determines whether or not a state where an occupant properly perform a steering operation is obtained based on a determination result of whether or not the determination task is completed and a determination result of a reaction of the occupant (whether an operation of the occupant is quick or slow) when the determination task is executed. Further, the controller 24 is electrically connected to the automatic driving system 22, and outputs a determination result of whether or not the occupant can perform the steering operation to the automatic driving system 22.

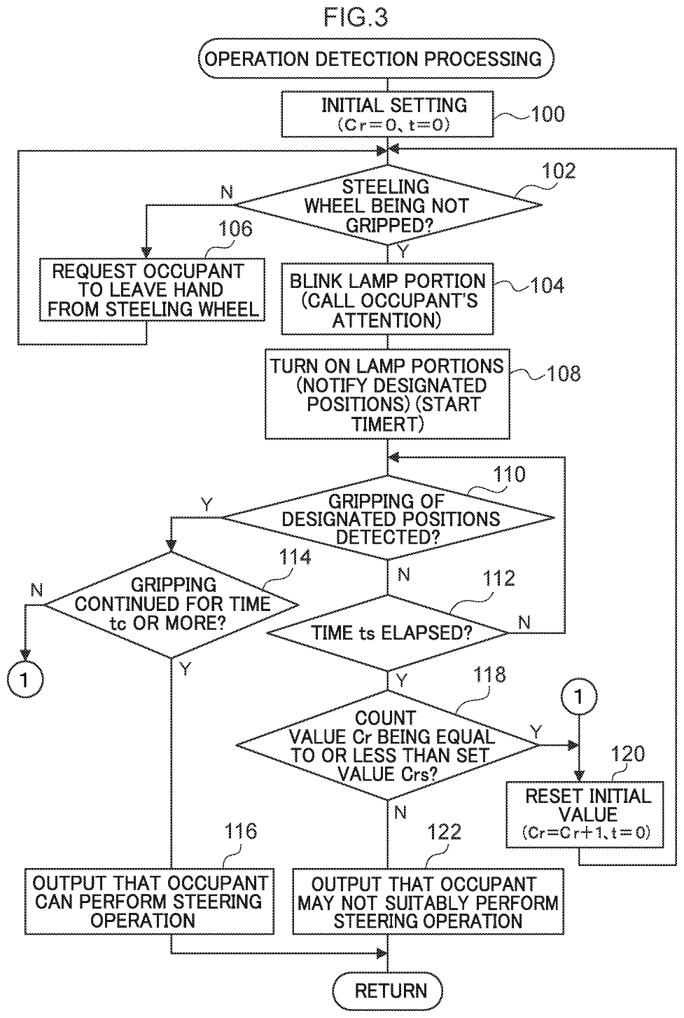

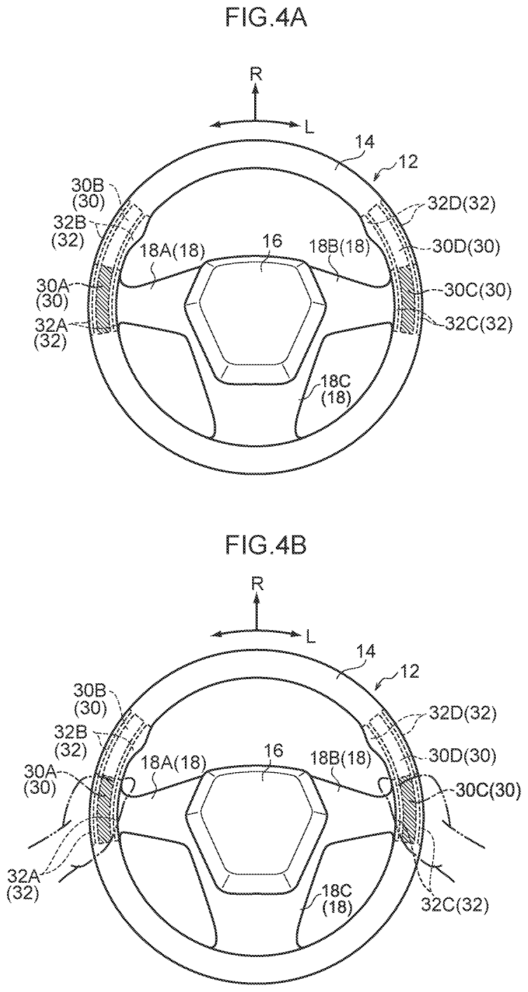

Next, as the manner of operation of this embodiment, processing performed by the controller 24 is described as the operation of the operation detection device 20. FIG. 3 is a flowchart schematically showing operation detection processing executed by the controller 24. FIG. 4A shows a state where the lamp portions 30 are turned on the steering wheel 12. FIG. 4B shows a state where an occupant grips the steering wheel 12.

When the automatic driving system 22 is operated in an automatic driving mode, a steering control of the vehicle is performed by the automatic driving system 22, and a state is brought about where it is determined that the occupant is leaving both hands off the steering wheel 12. In switching a driving mode from the automatic driving mode to the manual driving mode, when the occupant grips the steering wheel 12 to an extent that the steering wheel 12 is steerable, the automatic driving system 22 transfers an operation of the steering device 10 to the occupant thus switching the driving mode from the automatic driving mode to the manual driving mode. In such processing, the operation detection device 20 executes operation detection processing shown in FIG. 3, and determines whether or not a state is brought about where the occupant can grip the steering wheel 12 and can steer the vehicle.

The controller 24 clearly indicates the designated positions of the rim portions 14 by turning on the lamp portions 30A, 30C using the position which includes approximately a quarter after nine when the steering wheel 12 is used as a clock face as the designated position on the steering wheel 12. The controller 24 also determines whether or not the occupant has gripped the designated positions of the rim portion 14, and determines a reaction of an occupant by measuring a time period until the occupant completes such gripping.

In the first step 100 in FIG. 3, initial setting is performed. That is, the controller 24 resets a timer which measures a count value Cr and an elapsed time t of a re-try counter (Cr=0, t=0). In the next step 102, the controller 24 reads output signals of the sensors 32 (32A to 32D), and checks whether or not the steering wheel 12 is gripped by an occupant (whether or not the occupant is touching the steering wheel 12). In this step, the controller 24 performs necessary checks including a check of whether or not a state where an occupant is not gripping the steering wheel 12 continues for a predetermined time or more (for example, 1 second or more). The state in which the occupant is not gripping the steering wheel 12 is a state where none of the sensors 32A to 32D detects contact of the occupant with the rim portion 14 (a hand of the occupant not touching the rim portion 14). Such a state may be a state where an occupant is not touching at least the designated positions in the determination task.

In this step, when it is detected that a state where the occupant is not gripping the steering wheel 12 continues for a predetermined time period or more from a detection result of the sensor 32, an affirmative determination is made in step 102, and processing advances to step 104. When it is detected that the occupant is gripping the steering wheel 12, a negative determination is made in step 102, and processing advances to step 106 where the occupant is requested to temporarily leave his hand off the steering wheel 12 by a voice outputted from a speaker 34. Thereafter, step 102 is executed again.

In step 104, the lamp portions 30A to 30D are blinked to so as to call the occupant's attention to driving (calling the occupant's attention to performing a driving operation). In next step 108, the lamp portions 30A and 30C are turned on so as to designate the position (notifying the designated position) and the timer is started. In response to such an operation, as shown in FIG. 4A, the lamp portions 30A and 30C mounted on the rim portion 14 of the steering wheel 12 are turned on.

Thereafter, in step 110 of FIG. 3, it is checked whether or not the occupant is gripping the designated position by the sensors 32A to 32D. In step 112, it is checked whether or not an elapsed time t after turning on the lamp portion 30 has reached a predetermined time ts.

In general, when a physical condition of an occupant is both in a state which allows him to perform a driving operation of a vehicle and in a state which allows the occupant to concentrate his attention on the driving operation, when the lamp portions 30 are turned on, the occupant can grip portions of the lit lamp portions 30 on the rim portion 14 without delay.

On the other hand, there may be a case where the occupant is in a state where he cannot concentrate on the driving operation or the occupant is not in a physical condition which allows him to perform a driving operation (a case where the occupant is in an inattentive state). In such a case, even when the lamp portions 30 are turned on, there is a concern that the occupant does not recognize that the lamp portions 30 are in a lit state. Even when the occupant recognizes the lit state of the lamp portions 30, an action of the occupant has become so slow that it is difficult for the occupant to grip the portions of the lamp portions 30 on the rim portion 14 in a lit state without delay.

In this embodiment, as shown in FIG. 4B, when the occupant grips the lamp portions 30A and 30C mounted on the rim portion 14, the gripping of the lamp portions 30A and 30C is detected by the sensors 32A and 32C.

In FIG. 3, when the gripping of the portions of the lamp portions 30A and 30C is detected by the sensors 32A and 32C without delay after the occupant turns on the lamp portions 30A and 30C (a state where the negative determination is made in step 112, t<ts), the affirmative determination is made in step 110 and the processing advances to step 114.

In step 114, it is checked whether or not a state where the occupant is gripping the lamp portions 30A and 30C (a completion state of the determination task) continues for a predetermined time tc or more (for example, tc=3 seconds). When the gripping of the lamp portions 30A and 30C by the occupant continues for the time tc or more, the affirmative determination is made in step 114, and the processing advances to step 116.

In step 116, it is determined that a physical condition of the occupant is a physical condition which allows the occupant to perform a steering operation and a state which allows the occupant to concentrate on the steering operation (the state where the occupant is ready for performing a driving operation of the vehicle including a steering operation), and outputs a signal indicating a state that the occupant can properly operate the steering wheel 12 (outputs a signal indicating that an automatic driving mode can be shifted to a manual driving mode to the automatic driving system 22). With such processing, even when the vehicle is switched from an automatic driving mode to a manual driving mode, the occupant can perform a driving operation of the vehicle by properly performing the steering operation.

On the other hand, when the gripping of the rim portion 14 (portions of the lamp portions 30A and 30B) is detected by neither the sensor 32A nor the sensor 32C (a state where the negative determination is made in step 110), and an elapsed time t reaches a point of time ts (t≥ts), the affirmative determination is made in step 112 and the processing advances to step 118. The state where the gripping of the steering wheel 12 is not detected also includes a state where the gripping of the steering wheel 12 is detected by the sensors 32B and 32D because the occupant is not gripping the proper positions.

In this step 118, it is checked whether or not a count value Cr of a retry counter reaches a set value Crs (for example, Crs=2) which is preliminarily set. When count value Cr does not reach the set value Crs (Cr<Crs), the affirmative determination is made in step 118, and the processing advances to step 120. When at least one of hands of the occupant who is gripping the lamp portions 30A and 30C of the rim portion 14 is left from the rim portion 14, the negative determination is made in step 114, and the processing advances to step 120.

In step 120, an initial value is reset for performing the operation detection processing again (retry). In resetting the initial value, the count value Cr of the retry counter is incremented (Cr=Cr+1), and the timer is reset. Further, in performing such resetting, the designated positions of the determination task are changed. In the first determination task, the portions of the lamp portions 30A and 30C are set as the designated positions. However, in the processing performed next time, the designated positions are set at the portions of the lamp portions 30B and 30D (the positions including approximately ten after ten when the steering wheel 12 is used as a clock face of a clock). With such processing, whether or not the determination task is performed is detected by the sensors 32B and 32D. Then, when a predetermined interval time elapses, the processing advances to step 102, and the driving detection processing is performed again.

On the other hand, there may be a case where the operation detection processing is performed the number of times set in accordance with the set value Crs (Cr≥Crs), and it is not possible to detect that the occupant is properly gripping the designated portions (the portions of the lamp portions 30A and 30C or the portions of the lamp portions 30B and 30D) of the steering wheel 12 at proper timing at any time. In this case, the negative determination is made in step 118. When the negative determination is made in step 118, the processing advances to step 122. In step 122, it is determined that the occupant is not in a state where the occupant can perform proper driving operation of the vehicle or the occupant is not in a state where the occupant can concentrate on the driving operation, and based on such determination, a signal indicating that there is a possibility where the state of the occupant is a state not suitable for the steering operation is outputted (a signal indicating that shifting of the driving mode to the manual driving mode is not possible is outputted to the automatic driving system 22).

In this manner, the operation detection device 20 requests that the occupant performs the determination task where the occupant grips the designated positions of the steering wheel 12, and the operation detection device 20 determines whether or not the determination task is completed, and determines whether or not the occupant is in a state where the occupant can perform the steering operation based on the elapsed time t to the completion of the determination task when the determination task is completed. Accordingly, it is possible to determine whether or not the occupant can perform the proper driving operation of the vehicle. When it is determined that there is a possibility that the proper driving operation of the vehicle cannot be performed, the operation detection device 20 can detect a possibility that the state of the occupant is the state not suitable for the steering operation.

In general, in the automatic driving system 22, there may be a case where the driving mode is shifted from the automatic driving mode to the manual driving mode on a condition such as a condition where the occupant grips the steering wheel 12 or a condition where the occupant applies a predetermined rotational load to the steering wheel 12 (override). In such a case, when a physical condition of the occupant is not good or when the occupant cannot concentrate on the driving operation, there is a high possibility that the occupant performs the driving operation in an inattentive manner thus giving rise to a situation where the occupant cannot properly perform the driving operation of the vehicle. When the occupant touches the steering wheel 12 in an inattentive manner, in a state where the occupant does not recognize such touching, a driving mode may be switched from an automatic driving mode to a manual driving mode.

In this embodiment, when a driving mode is switched from the automatic driving mode to the manual driving mode on a condition that the occupant grips (touches) the steering wheel 12, there arises a situation where the occupant cannot perform the proper driving operation of the vehicle. That is, when the driving mode is shifted to the manual driving mode in the cases such as the case where the physical condition of the occupant is not good or the case where the occupant cannot concentrate on the driving operation, there is a high possibility that the driving operation of the vehicle cannot be performed properly.

On the other hand, the operation detection device 20 determines whether or not a physical condition of the occupant is a physical condition which allows the occupant to perform the steering operation, and whether or not the occupant is in a state where the occupant can concentrate on the steering operation. Based on such determination, the operation detection device 20 outputs that the occupant is in a state that the occupant can perform the steering operation when the physical condition of the occupant is the physical condition which allows the occupant to perform the steering operation, and the occupant is in a state where the occupant can concentrate on the steering operation. The operation detection device 20 outputs that there is a possibility that the occupant is in a state not suitable for the steering operation when it is determined that the physical condition of the occupant is the physical condition not suitable for steering operation or the occupant is in a state where the occupant cannot concentrate on the steering operation.

Accordingly, the automatic driving system 22 can stop switching of the driving mode from the automatic driving mode to the manual driving mode when it is determined that the physical condition of the occupant is the physical condition not suitable for performing the steering operation or the occupant is in a state where the occupant can concentrate on the steering operation. As a result, it is possible to prevent switching of the driving mode from the automatic driving mode to the manual driving mode in a state where the occupant is not suitable for performing the steering operation. Further, the automatic driving system 22 can perform an evacuation operation when the automatic driving system 22 continues the automatic driving mode without shifting the driving mode to the manual driving mode. As the evacuation operation, for example, when the vehicle is traveling on an expressway or a limited-access road, an evacuation location (an emergency vehicle stopping location) disposed on a road is named. Further, the vehicle may enter a parking area or the like and may be stopped. The vehicle may get off from a speedway or a limited-access road, and stops on a so-called general road. With such processing, when it is determined that the physical condition of the occupant is the physical condition not suitable for performing the steering operation or the occupant is in a state where the occupant cannot concentrate on the steering operation, it is possible to prevent the occurrence of an emergency state where a driving mode is switched from an automatic driving mode to a manual driving mode.

As a method of detecting the physical condition or the like of the occupant, a method which uses a living body information detection unit may be named. In the method, a heartbeat, a blood pressure, body movement and the like of the occupant are detected. Although the living body information detection unit can determine whether or not the occupant is performing the driving operation, it is difficult for the living body information detection unit to determine whether or not the occupant can concentrate on the driving. On the other hand, the operation detection device 20 requests that the occupant performs the determination task, and determines whether or not the occupant can easily perform proper driving operation based on whether or not the determination task is completed within the predetermined time.

The operation detection device 20 notifies the occupant of the designated positions by turning on the lamp portions 30. In performing the determination task, the designated positions can be notified also using a voice or the like. However, when the designated positions are notified by using a voice, there may be a case where the displacement occurs when the occupant recognizes the designated positions.

On the other hand, by turning on the lamp portions 30 mounted on the steering wheel 12, the occupant can clearly recognize the designated positions. Accordingly, it is possible to prevent the occurrence of erroneous determination caused by gripping of the position displaced from the designated position by the occupant. Accordingly, it is possible to prevent the occurrence of the erroneous determination that there is the possibility that it is determined that where the occupant is not suitable for performing the driving operation in spite of the state where the occupant can properly perform the driving operation. As a result, the driving mode can be properly shifted from the automatic driving mode to the manual driving mode.

Further, with respect to the straight advancing steering positions of the steering wheel 12 steered by the occupant, the designated positions are disposed on a right hand side and a left hand side of the occupant. With such arrangement, the determination task can be performed easily, and it is possible to properly determine whether or not a state where the occupant can perform the proper driving operation by the simple determination task is acquired.

When the number of the designated positions is set to three or more, it is necessary to grip a plurality of positions of the steering wheel 12 by at least one of two hands. Accordingly, the determination task is performed in a sense of playing a game. As a result, the consciousness of the occupant where the occupant wants to concentrate on the driving operation is decreased. On the other hand, by setting the designated positions at two portions, that is, on the left side portion and the right side portion of the steering wheel 12, it is possible to suppress the occurrence of the situation that the occupant performs the determination task in a sense of playing a game so that consciousness of the occupant that the occupant wants to concentrate on the driving operation is decreased.

Although the occupant cannot suddenly perform the steering operation, there may be a case where the occupant can perform a proper driving operation with sufficient preparation in advance. In this case, although the first determination task cannot be performed, the second determination task can be performed. The operation detection device 20 requests the determination task again in a case in which the completion of the determination task cannot be detected within the time ts. Accordingly, it is determined that a state where the occupant can perform the proper driving operation is acquired based on the determination task requested after the preparation of the occupant is completed. Accordingly, it is possible to prevent the occurrence of the situation where traveling in the automatic driving mode is continued in spite of the fact that the occupant can perform the proper driving operation.

At the time of requesting the determination task again, the designated positions are changed. With such processing, it is possible to suppress the occurrence of the state that the occupant is ready for gripping the same positions of the steering wheel 12 and hence, it is possible to perform more accurate determination with respect to whether or not the occupant is in a state where the occupant can perform the proper driving.

Further, the operation detection device 20 determines whether or not the occupant is in a state suitable for performing driving operation by repeating the determination tasks plural times. Accordingly, when the occupant is in a state where the occupant cannot properly perform the driving operation, it is possible to determine with high accuracy that the occupant is in a state where the occupant cannot properly perform the driving operation. Furthermore, at the time of determining that the occupant is in a state where the occupant cannot properly perform driving operation, the automatic driving system continues the automatic driving mode, performs an evacuation operation, and further, notifies the surroundings of the occurrence of an emergency state and hence, the occupant can avoid the emergency state.

As has been described heretofore, in this embodiment, the occupant is asked to pay attention by blinking the lamp portions 30 in step 104 in FIG. 3, and the lamp portions 30 (30A, 30C) are turned on in step 108. However, blinking of the lamp portions 30 in step 104 may be omitted. Particularly, in the case where the determination task is requested again, it is preferable that processing in step 104 is omitted. Further, the lighting of the lamp portions 30 in step 108 may be replaced with blinking.

In requesting the determination task, the time ts may be set different between the first determination task and the next determination task. In this case, when the determination task is requested again, there is a possibility that the occupant is ready for the determination task. Accordingly, it is preferable that the time ts for the succeeding determination task is set shorter than the time ts for the preceding determination task.

Further, in step 114 in FIG. 3, the time tc is set to 3 seconds or more. However, this time tc may be 3 seconds or less. Particularly, after the operation detection processing is completed, the automatic driving system 22 shifts the driving mode from the automatic driving mode to the manual driving mode and hence, the occupant continues gripping of the steering wheel 12. Accordingly, the time tc may be set 3 seconds or less, and processing in step 114 may be omitted.

In this embodiment, the designated positions of the steering wheel 12 in the determination task are set to the portions of the lamp portions 30A and 30C or the portions of the lamp portions 30B and 30D. However, the designated positions may be the portion of the lamp portion 30A and the portion of lamp portion 30D or the portion of the lamp portion 30B or the portion of the lamp portion 30C.

With respect to the straight advancing steering position of the vehicle, it is often the case where the positions of the portions of the steering wheel 12 which the occupant grips differ depending on the occupant. In view of the above, when the vehicle travels in a manual operation mode, a time during which the gripping of the steering wheel 12 by the occupant is detected is measured with respect to the respective sensors 32A to 32D, and the designated positions in the determination task may be set based on a result of this measurement. In such an operation, with respect to the sensors 32A and 32B, the position that corresponds to the sensor 32 having a shorter detection time may be set as the designated position, and with respect to the sensors 32C and 32D, the position which corresponds to the sensor 32 having a shorter detection time may be set as the designated position. Accordingly, at the time of performing the determination task, it is possible to prevent that the gripping of the steering wheel 12 by the occupant in an inattentive state is erroneously determined as the completion of the determination task. Accordingly, it is possible to prevent the occurrence of erroneous determination in determining whether or not the occupant is in a state where the occupant can perform the proper driving operation.

In this embodiment, the description has been made with respect to the case where the operation detection device 20 which forms an operation status detection device is operated based on a request when the automatic driving system 22 shifts the driving mode from the automatic driving mode to the manual driving mode. However, the operation status detection device can be operated when the vehicle is traveling in the automatic driving mode (when the vehicle is traveling in a state where the steering operation by the occupant is unnecessary). Accordingly, the operation status detection device can be used in such a manner that the operation status detection device is operated at arbitrary timing when the vehicle is traveling in an automatic driving mode so as to detect a physical condition of the occupant or the like.

In this embodiment, the operation detection device 20 which forms the operation status detection device is mounted on the steering device 10. However, the automatic driving system 22 which forms a driving assist device may have a function of a determination part of the operation status detection device. Accordingly, the driving assist device can detect whether or not the occupant is in a state suitable for the driving operation.

The disclosure of Japanese Patent Application No. 2017-179944 filed on Sep. 20, 2017 is incorporated herein by reference in its entirety.

All literatures, patent applications and technical standards described in this specification are incorporated in this specification by reference in the same manner as the case where the inclusion of the individual literatures, the individual patent applications and the individual technical standards by reference are specifically and individually described.

1. An operation status detection device, comprising:
a request part configured to request that an occupant performs an operation task of gripping a designated position of a steering wheel, which is gripped and operated by the occupant when the occupant performs a driving operation, and which is operated by a driving assist device of a vehicle when the driving operation is performed by the driving assist device;
a detection part configured to detect the operation task of the occupant relative to the steering wheel; and
a determination part configured to determine whether or not the occupant is able to operate the steering wheel based on whether or not completion of the operation task is detected by the detection part within a predetermined time after the request part requests the operation task.

2. The operation status detection device according to claim 1, wherein the request part includes a light emitting part that is mounted on the steering wheel, and that performs one of calling an occupant's attention to performance of the operation task or notifying the occupant of the designated position, by being turned on.

3. The operation status detection device according to claim 1, wherein the designated position is disposed at one place on each of left and right sides, with respect to a vehicle straight advancing steering position, of the steering wheel.

4. The operation status detection device according to claim 3, wherein: the operation status detection device includes a plurality of the detection parts on each of the left and right sides, with respect to the vehicle straight advancing steering position, of the steering wheel, and
the designated position is a position that corresponds to the detection part at which a gripping time of the occupant, which is preliminarily detected by the detection part in a case in which the vehicle travels in a manual operation mode, is shortest at the respective left and right sides with respect to the vehicle straight advancing steering position of the steering wheel.

5. The operation status detection device according to claim 1, wherein the determination part is configured to determine that the occupant is able to operate the steering wheel in a case in which completion of the operation task is detected within a predetermined time after the operation task is requested.

6. The operation status detection device according to claim 1, wherein the determination part is configured to determine that the occupant is able to operate the steering wheel in a case in which a completion state of the operation task continues.

7. The operation status detection device according to claim 1, wherein the request part requests the operation task again in a case in which completion of the operation task is not detected within a predetermined time after the operation task is requested.

8. The operation status detection device according to claim 7, wherein the designated position is changed when the operation task is requested again.

9. The operation status detection device according to claim 7, wherein the determination part is configured to determine that the occupant is not able to operate the steering wheel when the completion of the operation task is not detected within the predetermined time despite the operation task having been requested a predetermined number of times.
